(19) United States
(12) Patent Application Publication
(10) Pub. No.: US 2013/0307715 A1
(43) Pub. Date: Nov. 21, 2013

(54) Methods and Systems for Predicting Jamming Effectiveness

(71) Applicants: William H. Davis, Columbia City, IN (US); John H. VanPatten, Columbia City, IN (US); Anthony T. McDowell, Fort Wayne, IN (US); Lee A. McMillan, Fort Wayne, IN (US)

(72) Inventors: William H. Davis, Columbia City, IN (US); John H. VanPatten, Columbia City, IN (US); Anthony T. McDowell, Fort Wayne, IN (US); Lee A. McMillan, Fort Wayne, IN (US)

(73) Assignee: Raytheon Corporation, Waltham, MA (US)

(21) Appl. No.: 13/475,233

(22) Filed: May 18, 2012

(51) Int. Cl. G01S 7/38

(52) U.S. Cl. 342/14

(57) ABSTRACT

Disclosed subject matter relates to techniques for predicting jamming effectiveness. In one approach, platform models and propagation models are used to predict maximum threat communication range when jamming is used and when jamming is not used. The maximum range information may then be used to calculate jammer effectiveness. In another approach, probability-based techniques are used to predict jamming effectiveness for a system of interest.

### FIELD

Disclosed subject matter relates generally to radio frequency (RF) systems and, more particularly, to techniques and systems for predicting and analyzing the effectiveness of jamming activities in real world scenarios.

### BACKGROUND

During jamming operations, a jamming transmitter is typically used to direct a jamming signal toward a threat receiver to disrupt operation of the threat receiver. The jamming may be attempting to disrupt, for example, a communication link between a threat transmitter and the threat receiver. There is a need for techniques to accurately determine how effective a jamming transmitter design will be at disrupting threat communications in real world scenarios. It would be beneficial if these techniques could be performed during a transmitter design phase, before costs are incurred to actually build a transmitter, to reduce system development costs should a redesign of the jamming transmitter be needed.

### SUMMARY

In accordance with the concepts, systems, circuits, and techniques described herein, a machine-implemented method for predicting jamming effectiveness, comprises: receiving input information specifying a threat receiver platform model describing a threat receiver; receiving input information specifying a threat transmitter platform model describing a threat transmitter; receiving input information specifying a jamming transmitter platform model describing a jamming transmitter; receiving input information specifying a first channel propagation model for a channel between the threat transmitter and the threat receiver; receiving input specifying a second channel propagation model for a channel between the jamming transmitter and the threat receiver; receiving input information specifying a number of threat transmitter locations; and performing a first series of interference analyses corresponding to the number of threat transmitter locations using the threat receiver platform model, the threat transmitter platform model, the jamming transmitter platform model, the first channel propagation model, and the second channel propagation model, each of the first series of interference analyses resulting in a receiver performance metric value, wherein the first series of interference analyses hold the location of the jamming transmitter and the threat receiver constant.

In accordance with a further aspect of the concepts, systems, circuits and techniques described herein, a system for predicting jamming effectiveness, comprises: one or more processors to: receive input information specifying a threat receiver platform model describing a threat receiver; receive input information specifying a threat transmitter platform model describing a threat transmitter; receive input information specifying a jamming transmitter platform model describing a jamming transmitter; receive input information specifying a first channel propagation model for a channel between the threat transmitter and the threat receiver; receive input specifying a second channel propagation model for a channel between the jamming transmitter and the threat receiver; receive input information specifying a number of threat transmitter locations; and perform a first series of interference analyses corresponding to the number of threat transmitter locations using the threat receiver platform model, the threat transmitter platform model, the jamming transmitter platform model, the first channel propagation model, and the second channel propagation model, each of the first series of interference analyses resulting in a receiver performance metric value, wherein the first series of interference analyses hold the location of the jamming transmitter and the threat receiver constant; and a memory to store a library of transmitter models, receiver models, antenna models, propagation models, and channel parameter models for use in generating platform models.

In accordance with a still further aspect of the concepts, systems, circuits and techniques described herein, a machine implemented method for analyzing jamming effectiveness for a jamming transmitter that is intended to disrupt communications between a threat transmitter and a threat receiver, comprises: for a plurality of threat communication link ranges, calculating a median, a lower half standard deviation, and an upper half standard deviation for a probability density function for communication path loss using a first propagation model, wherein a threat communication link range is a range between the threat transmitter and the threat receiver; for one or more jamming link ranges, calculating a median, a lower half standard deviation, and an upper half standard deviation for a probability density function for jamming path loss using the first propagation model, wherein a jamming link range is a range between the jamming transmitter and the threat receiver; for each desired range combination, generating a probability density function for a difference between jammer path loss and threat communication path loss using the median, the lower half standard deviation, and the upper half standard deviation for the probability density function for threat communication path loss and the median, the lower half standard deviation, and the upper half standard deviation for the probability density function for jammer path loss, wherein a range combination is a combination of a threat communication link range and a jamming link range; and for each desired range combination, using the probability density function for the difference between jammer path loss and threat communication path loss to determine a jammer effectiveness probability.

In accordance with yet another aspect of the concepts, systems, circuits and techniques described herein, a system for predicting jamming effectiveness for a jamming transmitter that is intended to disrupt communications between a threat transmitter and a threat receiver, comprises: one or more processors to: calculate a median, a lower half standard deviation, and an upper half standard deviation for a probability density function for communication path loss using a first propagation model for a plurality of threat communication link ranges, wherein a threat communication link range is a range between the threat transmitter and the threat receiver; calculate a median, a lower half standard deviation, and an upper half standard deviation for a probability density function for jamming path loss using the first propagation model for one or more jamming link ranges, wherein a jamming link range is a range between the jamming transmitter and the threat receiver; generate a probability density function for a difference between jammer path loss and threat communication path loss using the median, the lower half standard deviation, and the upper half standard deviation for the probability density function for threat communication path loss and the median, the lower half standard deviation, and the upper half standard deviation for the probability density function for jammer path loss for each desired range combination, wherein a range combination is a combination of a threat communication link range and a jamming link range; and for each desired range combination, use the corresponding probability density function for the difference between jammer path loss and threat communication path loss to determine a jammer effectiveness probability; and a memory to store generated probability density functions.

### BRIEF DESCRIPTION OF THE DRAWINGS

The foregoing features of this invention, as well as the invention itself, may be more fully understood from the following description of the drawings in which:

FIG. 1 is a block diagram illustrating an example computing system architecture that may be used in one or more implementations;

FIG. 2 is a block diagram illustrating an example jamming scenario that may be simulated using the principles and concepts described herein;

FIGS. 3 and 4 are portions of a flow diagram showing an example process for use in predicting jammer effectiveness in accordance with an implementation;

FIG. 5 is a block diagram illustrating an example analysis system for simulating/predicting jamming effectiveness in accordance with an embodiment;

FIG. 6 is a screen shot of a GUI screen that may be used in connection with radio model application in accordance with an implementation;

FIG. 7 is a screen shot of an example GUI screen that may be used in connection with antenna model application in accordance with an implementation;

FIG. 8 is a screen shot of an example GUI screen that may be used in connection with a receive RFD dataset application in accordance with an implementation;

FIG. 9 is a screen shot of an example GUI screen that may be used in connection with a transmit datasets application in accordance with an implementation;

FIG. 10 is a screen shot of an example GUI screen that may be used in connection with a channel parameters application in accordance with an implementation;

FIG. 11 is a screen shot of an example GUI screen that may be used in connection with a propagation model application in accordance with an implementation;

FIG. 12 is a screen shot of an example GUI screen that may be used in connection with a platform model application in accordance with an implementation;

FIG. 13 is a screen shot of an example GUI screen that may be used in connection with a Multi-Platform Scenario application in accordance with an implementation;

FIG. 14 is a screen shot of an example GUI screen that may be used in connection with a Range/Bearing Sweep Analysis application in accordance with an implementation;

FIG. 15 is a screen shot of a GUI screen that may be used in connection with inter-platform coupling application in accordance with an implementation;

FIG. 16 is a flow diagram illustrating an example method for determining jammer effectiveness using probabilistic techniques in accordance with an implementation;

FIG. 17 illustrates an example equation that may be used to generate a probability density function (pdf) for a difference between a jammer path loss and a communication path loss for a particular range combination in accordance with an embodiment;

FIG. 18 is a plot illustrating an example pdf that may be generated for a difference between a jammer path loss and a communication path loss for a particular range combination in accordance with an implementation; and

FIG. 19 is a screen shot of a GUI screen that may be used as part of a probability based jamming effectiveness application in accordance with an implementation.

### DETAILED DESCRIPTION

The subject matter described herein relates to tools and techniques that may be used to accurately predict the effectiveness of jamming operations in real world scenarios. In certain embodiments, the tools and techniques may be used during the design phase of a jamming transmitter to determine the jamming effectiveness of the transmitter before an actual transmitter circuit is built. Various approaches for analyzing and predicting jammer effectiveness are provided. In one approach, for example, platform models may be generated or selected to accurately describe the operation of a jamming transmitter, a threat transmitter, and a threat receiver in an environment of interest. Propagation models may also be specified for characterizing corresponding propagation channels (e.g., a channel between the jamming transmitter and the threat receiver and a channel between the threat transmitter and the threat receiver) to more accurately predict signal propagation loss in the channels. Interference analyses may then be performed for a plurality of different threat transmitter locations using the jamming transmitter platform model, the threat transmitter platform model, the receiver platform model, and the propagation models. The results of the interference analyses may then be compared to results achieved when no jamming was specified to determine the effectiveness of the jamming. The effectiveness information may then be plotted for a user.

In another approach, probability based techniques may be used to predict jamming effectiveness for a system. In this approach, probability density functions (pdfs) are determined for a difference between a jammer path loss (JPL) and a threat communication path loss (CPL) for a number of different jammer range and threat range combinations. The pdfs may then be integrated over specific ranges to determine jamming effectiveness probability data. The specific integration ranges may be determined based on, for example, conditions known or believed to produce an effective jam. The jamming effectiveness probability data may be plotted and displayed to a user.

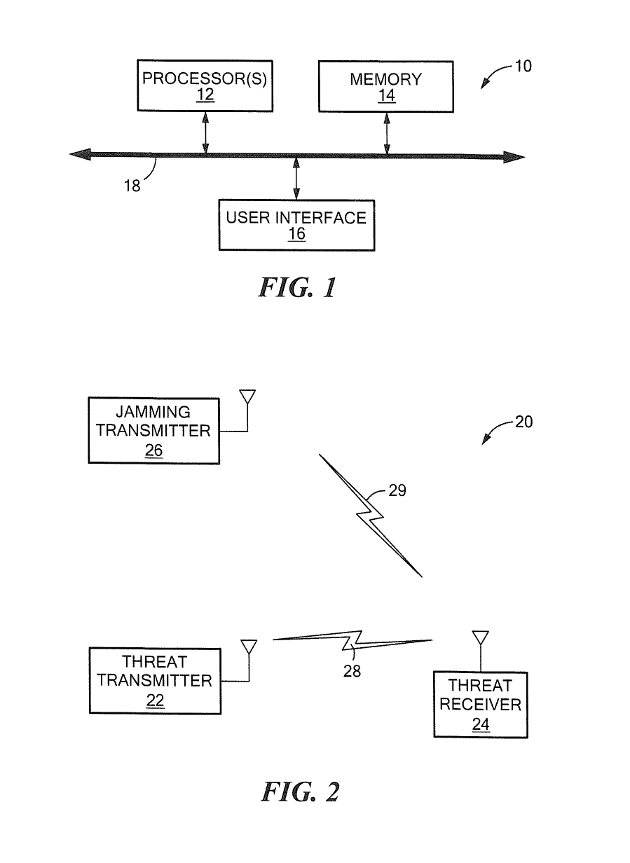

FIG. 1 is a block diagram illustrating an example computing system architecture 10 that may be used in one or more implementations. As illustrated, the computing system architecture 10 may include: one or more digital processors 12, a memory 14, and a user interface 16. A bus 18 and/or other structure(s) may be provided for establishing interconnections between various components of computing system architecture 10. In some implementations, one or more wired or wireless networks may be provided to support communication between elements of computing system 10. Digital processor(s) 12 may include one or more digital processing devices that are capable of executing programs or procedures to provide functions and/or services for a user. Memory 14 may include one or more digital data storage systems, devices, and/or components that may be used to store data and/or programs for use by other elements of architecture 10. User interface 16 may include any type of device, component, or subsystem for providing an interface between a user and system 10.

Digital processor(s) 12 may include, for example, one or more general purpose microprocessors, digital signals processors (DSPs), controllers, microcontrollers, application specific integrated circuits (ASICs), field programmable gate arrays (FPGAs), programmable logic arrays (PLAs), programmable logic devices (PLDs), reduced instruction set computers (RISCs), and/or other processing devices or systems, including combinations of the above. Digital processor(s) 12 may be used to, for example, execute an operating system and/or one or more application programs. In addition, digital processor(s) 12 may be used to implement, either partially or fully, one or more of the analysis processes or techniques described herein in some implementations.

Memory 14 may include any type of system, device, or component, or combination thereof, that is capable of storing digital information (e.g., digital data, computer executable instructions and/or programs, etc.) for access by a processing device or other component. This may include, for example, semiconductor memories, magnetic data storage devices, disc based storage devices, optical storage devices, read only memories (ROMs), random access memories (RAMs), non-volatile memories, flash memories, USB drives, compact disc read only memories (CD-ROMs), DVDs, Blu-Ray disks, magneto-optical disks, erasable programmable ROMs (EPROMs), electrically erasable programmable ROMs (EEPROMs), magnetic or optical cards, and/or other digital storage suitable for storing electronic instructions and/or data. In some implementations, memory 14 may store one or more programs for execution by processor(s) 12 to implement analysis processes or techniques described herein. Memory 14 may also store one or more databases or libraries of model data for use during various analyses.

User interface 16 may include one or more input/output devices (e.g., a display, a mouse, a trackball, a keyboard, a numerical keypad, speakers, a microphone, etc.) to allow users to interact with computing system architecture 10. User interface 16 may also include executable software and a processor that is capable of soliciting input from a user for use in the performance of various analyses and/or other processes. In at least one implementation, user interface 16 includes a graphical user interface (GUI). Although user interface 16 is illustrated as a separate unit, it should be understood that, in some implementations, some or all of the user interface functions may be performed within processor(s) 12.

As will be described in greater detail, in some implementations, a user will be able to define a jamming effectiveness analysis to be performed via user interface 16. One or more processes may then be executed within processors 12 to carry out the jamming effectiveness analysis. The results of an analysis (e.g., data, a plot, etc.) may be presented to a user via user interface 16 and/or saved to memory 14. During the performance of the analysis, one or more databases or libraries stored within memory 14 may be accessed to provide models and/or other data for use in the analysis.

It should be appreciated that the computing system architecture 10 of FIG. 1 represents one example of an architecture that may be used in an implementation. Other architectures may alternatively be used. It should be appreciated that all or part of the various devices, processes, or methods described herein may be implemented using any combination of hardware, firmware, and/or software.

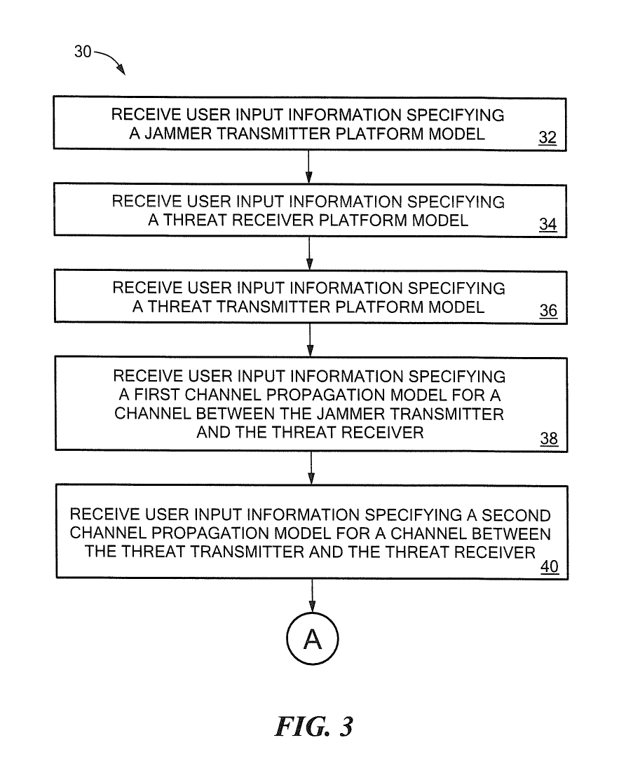

FIG. 2 is a block diagram illustrating an example jamming scenario 20 that may be simulated using the principles and concepts described herein. As shown, a threat transmitter 22 is communicating through a wireless link 28 with a threat receiver 24. A jamming transmitter 26 associated with an adverse entity may desire to disrupt the communication between threat transmitter 22 and threat receiver 24. To do this, jamming transmitter 26 may transmit a wireless jamming signal toward threat receiver 24 through a wireless channel 29. If the signal level of the jamming signal is high enough at the threat receiver location, it will compromise the threat receiver's ability to reliably receive and decode signals from threat transmitter 22. In various implementations discussed herein, techniques and systems are described that allow the effectiveness of a jamming transmitter at disrupting threat communications to be predicted for a given operational scenario, even before an actual jamming transmitter circuit is built.

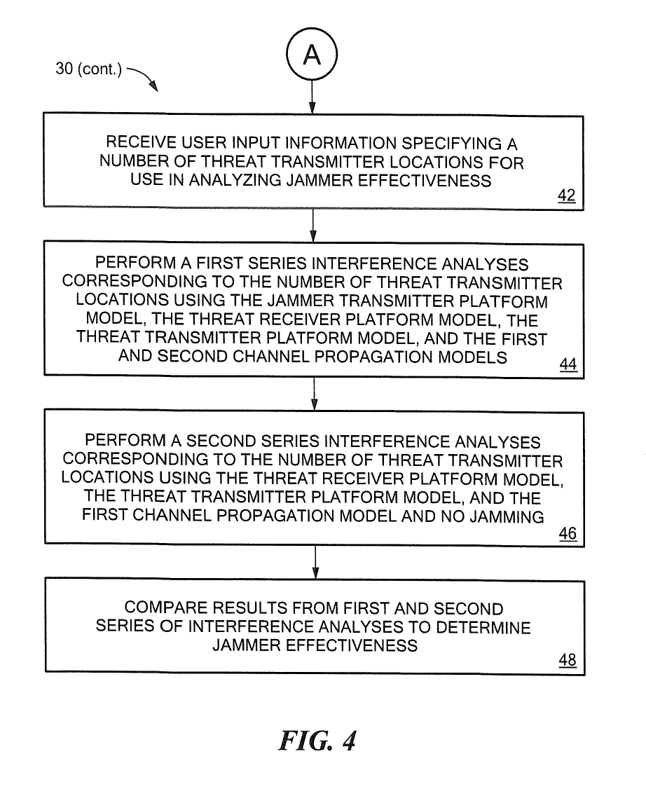

FIGS. 3 and 4 are portions of a flow diagram showing an example process for use in predicting jammer effectiveness in accordance with an implementation.

The rectangular elements in FIGS. 3 and 4 (typified by element 32 in FIG. 3), and in other flow diagrams herein, are denoted “processing blocks” and may represent computer software instructions or groups of instructions. It should be noted that the flow diagram of FIGS. 3 and 4 represents one exemplary embodiment of a design described herein and variations in such a diagram, which generally follow the process outlined, are considered to be within the scope of the concepts, systems, and techniques described and claimed herein.

Alternatively, the processing blocks may represent operations performed by functionally equivalent circuits, such as a digital signal processor circuit, an application specific integrated circuit (ASIC), or a field programmable gate array (FPGA). Some processing blocks may be manually performed while other processing blocks may be performed by a processor. The flow diagram does not depict the syntax of any particular programming language. Rather, the flow diagram illustrates the functional information one of ordinary skill in the art may require to fabricate circuits and/or to generate computer software to perform the processing required of the particular apparatus. It should be noted that many routine program elements, such as initialization of loops and variables and the use of temporary variables may not be shown. It will be appreciated by those of ordinary skill in the art that unless otherwise indicated herein, the particular sequence described is illustrative only and can be varied without departing from the spirit of the concepts described and/or claimed herein. Thus, unless otherwise stated, the processes described below are unordered meaning that, when possible, the sequences shown in FIGS. 3 and 4 and other flow diagrams herein can be performed in any convenient or desirable order.

Turning now to FIGS. 3 and 4, an example method 30 for predicting jammer effectiveness for a given operational scenario will be described. User input information is first received that specifies a jamming transmitter platform model to be used for a jammer effectiveness analysis (block 32). The jamming transmitter platform model is a model of a platform that includes the jamming transmitter that will attempt to disrupt threat communication operations. The user may select the jamming transmitter platform model from a plurality of platform models stored in a model library or database. User input information may also be received that specifies a threat receiver platform model to be used for the jamming effectiveness analysis (block 34). The threat receiver platform model is a model of a platform that includes the threat receiver that will receive energy transmitted from a threat transmitter. User input information may also be received that specifies a threat transmitter platform model to be used for the jammer effectiveness analysis (block 36). The threat transmitter platform model is a model of a platform that includes the threat transmitter communicating with the threat receiver. As with the jamming transmitter platform model, the user may select the threat receiver platform model and the threat transmitter platform model from, for example, models stored in a model library in some implementations. User input information may also be received that specifies channel propagation models to use to characterize radio frequency propagation. A first channel propagation model may be specified for use in a channel between the jamming transmitter platform and the threat receiver platform (block 38). A second channel propagation model may be specified for use in a channel between the threat transmitter platform and the threat receiver platform (block 40).

Turning now to FIG. 4, user input information may also be received that specifies a number of threat transmitter locations to use in performing the jamming effectiveness analysis (block 42). The threat transmitter locations may be specified in any known manner. Stationary locations may be specified for the jamming transmitter and the threat receiver. After the input information has been collected and the models have been generated or retrieved, a first series of interference analysis operations may be performed for the specified threat transmitter locations using the jamming transmitter platform model, the threat receiver platform model, the threat transmitter platform model, and the first and second propagation models (block 44). During the interference analyses, the location of the threat transmitter platform may be swept through the specified locations and resulting receive metrics may be calculated and stored for the threat receiver (e.g., carrier-to-noise ratio (CNR), etc.). Any interference analysis technique or program may be used to perform the interference analyses. In at least one embodiment, a COMSET interference analysis tool developed and owned by Raytheon Corporation is used to perform the interference analyses. The COMSET interference analysis tool is described in U.S. Pat. No. 8,086,187 to Davis et al. which is co-owned with the present application and is hereby incorporated by reference in its entirety. A second series of interference analysis operations may then be performed for the specified threat transmitter locations where no jamming is used (block 46). The same interference analysis technique or program may be used to perform the second series of interference analyses.

The results of the first and second series of analyses may then be compared to determine the jamming effectiveness (block 48). In at least one implementation, a jamming effectiveness metric may be defined as follows:

$${J}_{eff} = ( 1 - \frac{{R}_{j}}{{R}_{max}} ) \times 100 \% .$$

where J_{eff} is the jamming effectiveness, Rⱼ is the maximum threat communication range with the jammer on, and Rₘₐₓ is the maximum communication range with the jammer off. The results from the first series of interference analysis operations may be processed to determine Rⱼ. That is, the results may be analyzed to determine which threat communication range produces a minimum CNR value (or other metric value) required for reliable signal detection when jamming is used. Similarly, the results of the second series of interference analysis operations may be processed to determine Rₘₐₓ. That is, these results may be analyzed to determine which threat communication range produces a minimum CNR value (or other metric value) required for reliable signal detection when jamming is not used. After Rⱼ and Rₘₐₓ have been found, J_{eff} may be calculated using the above equation. In different implementations, jamming effectiveness values may be calculated for one direction or various different directions from the threat receiver location.

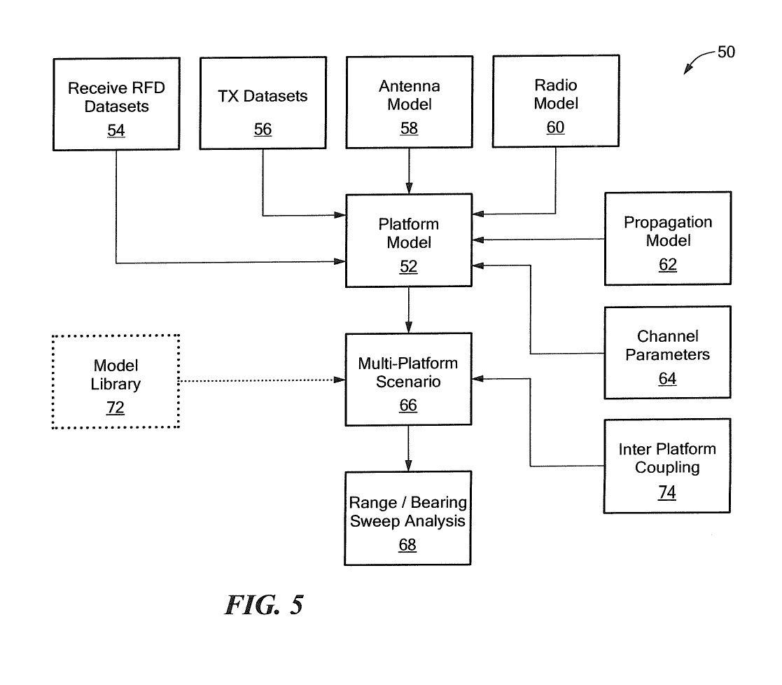

FIG. 5 is a block diagram illustrating an example analysis system 50 for simulating/predicting jamming effectiveness in accordance with an embodiment. In at least one implementation, the system 50 may be part of, for example, a suite of system analysis tools for analyzing various aspects of a system design. One such suite of tools is the COMSET analysis system developed and owned by Raytheon Corporation. With reference to FIG. 5, the analysis system 50 may include: a platform model application 52, a receiver radio frequency distribution (RFD) datasets application 54, a transmit datasets application 56, an antenna model application 58, a radio model application 60, a propagation model application 62, a channel parameters application 64, a multi-platform scenario application 66, a range/bearing sweep analysis application 68, and an inter-platform coupling application 74. The applications 52, 54, 56, 58, 60, 62, 64, 66, 68, 74 in FIG. 5 may represent, for example, individual applications executing in a processor (e.g., processor(s) 12 of computing system architecture 10 of FIG. 1). Some or all of the blocks 52, 54, 56, 58, 60, 62, 64, 66, 68, 74 may also, in some implementations, include a graphical user interface (GUI) to facilitate entry of information by a user. Analysis system 50 may also include a model library/database 72 to store models created by the various components. Model library 72 may be stored within memory of system 50 (e.g., memory 14 of computing system architecture 10 of FIG. 1).

As will be described in greater detail, receive RFD datasets application 54, transmit datasets application 56, antenna model application 58, radio model application 60, propagation model application 62, and channel parameters application 64, may each be used to create and/or modify models and datasets for use in jammer effectiveness analyses and/or other analyses. Platform model application 52 is operative for generating platform models for use during jammer effectiveness analyses using models and datasets generated by the other applications 54, 56, 58, 60, 62, and 64. Multi-Platform Scenario application 66 allows a user to specify multiple platform models to be used during a jammer effectiveness analysis. Range-bearing sweep analysis application 68 is operative for performing the calculations required to generate jammer effectiveness information for a given scenario. Range-bearing sweep analysis application 68 may allow a user to specify, among other things, a propagation model to use for the channel between the threat transmitter platform and the threat receiver platform during a jammer effectiveness analysis. Range-bearing sweep analysis application 68 may also allow a user to specify a type of plot to use to plot results of a jammer effectiveness analysis. Inter-platform coupling application 74 is operative for allowing a user to specify a propagation model to use for the channel between the jamming transmitter platform and the threat receiver platform.

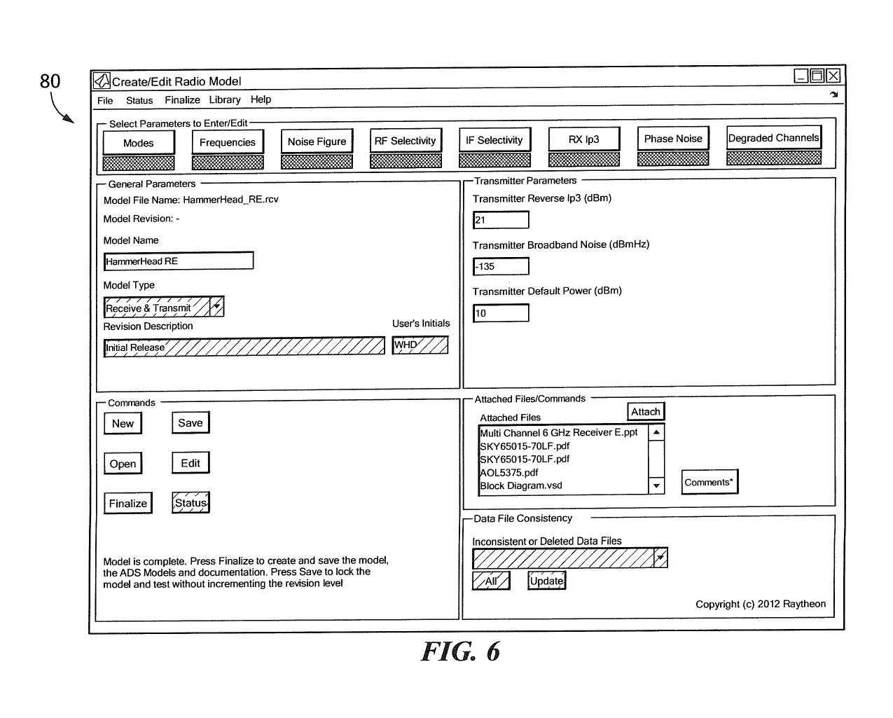

Radio model application 60 of FIG. 5 may be used to create or modify radio models in one or more embodiments. FIG. 6 is a screen shot of a GUI screen 80 that may be used in connection with radio model application 60 in accordance with an implementation. A radio model contains data characterizing an exciter and receiver's performance. However, this model does not contain all data for an entire transmitter and receiver system. For the transmitter system, a power amplifier, filter, coax, etc. may be added to the exciter performance, but the final transmitter performance data may be generated in Agilent's Advanced Design System (ADS) (or some other electronic design automation software). For the receiver, a low noise amplifier, filter, coax, etc. may be added to the radio (receiver) model, where the data for just these components is simulated in ADS. These components can be referred to as the Radio Frequency Distribution (RFD).

After the radio model has been created, an ADS exciter model may be automatically generated. The ADS exciter model is created from the modulation, phase noise, thermal noise, power, and reverse 3^{rd} order intercept data in the radio model. This exciter model, along with other components that may be included (e.g., power amplifier, etc.), is simulated in ADS to create a transmit dataset. The data created includes output power as a function of frequency, thermal and phase noise power spectral density as a function of frequency and offset frequency, selectivity after power amplifier, and reverse 3^{rd} order intercept power. The receiver RFD components are also simulated in ADS and characterized for noise figure as a function of frequency, selectivity as a function of frequency and offset frequency, and 3^{rd} order intercept power as a function of frequency and offset frequency. The output from this simulation is the receive RFD dataset. The data imported into radio model application 60 can be theoretical, simulated, and/or measured. Once a radio model has been created using radio model application 60, it can stored in and accessed from model library 72 of FIG. 5.

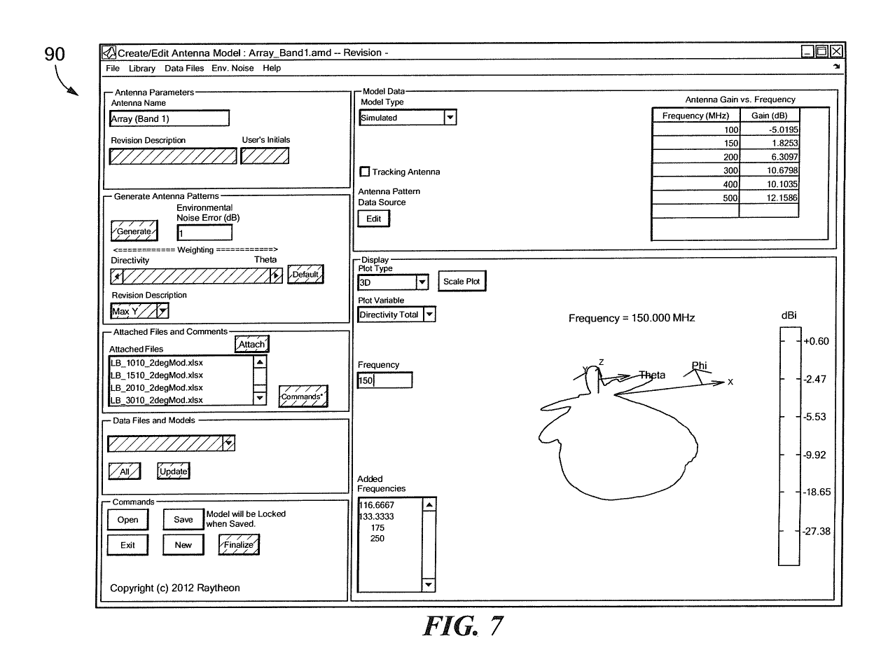

Antenna models can be created in antenna model application 58 of FIG. 5 in accordance with some embodiments. FIG. 7 is a screen shot of an example GUI screen 90 that may be used in connection with antenna model application 58 in accordance with an implementation. In at least one implementation, antenna model application 58 may allow a user to create theoretical antenna patterns (e.g., dipole, monopole, and directional) for use in antenna models for jamming effectiveness simulations. Antenna model application 58 may also, or alternatively, allow a user to import data from electromagnetic (EM) simulator programs (e.g., CST Microwave Studio, etc.) for use in antenna models for jamming effectiveness simulations. In some implementations, antenna model application 58 may also allow a user to import measured antenna data for use in antenna models for jamming effectiveness simulations. This application may also include functionality to provide the complex orthogonal components of directivity (i.e., directivity theta and phi and their phase) in spherical coordinates. Once an antenna model has been created using antenna model application 58, it can be stored in and accessed from model library 72 of FIG. 5.

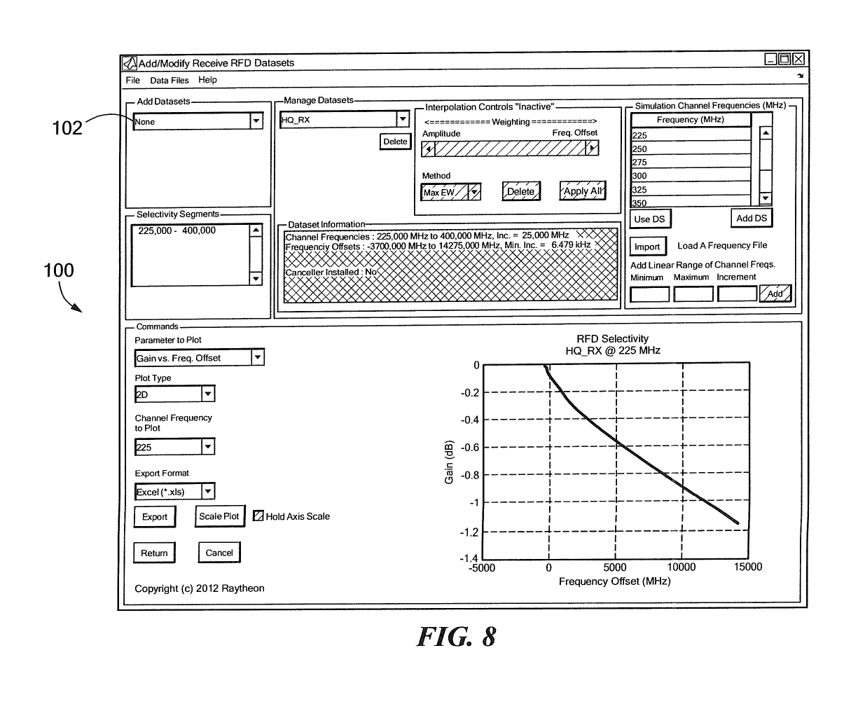

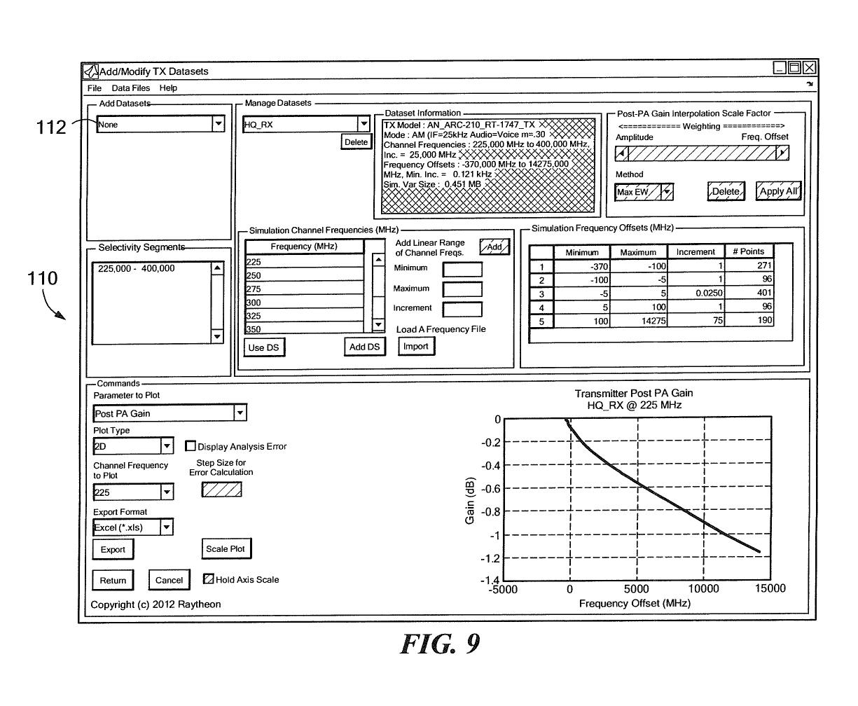

Receive RFD dataset application 54 of FIG. 5 may be used to add and/or modify stored RFD datasets. FIG. 8 is a screen shot of an example GUI screen 100 that may be used in connection with receive RFD dataset application 54 in accordance with an implementation. As illustrated, GUI screen 100 includes a pull-down menu 102 that may be used by a user to add one or more RFD datasets to a platform model. Transmit datasets application 56 of FIG. 5 may be used to add and/or modify stored transmit datasets. FIG. 9 is a screen shot of an example GUI screen 110 that may be used in connection with transmit datasets application 56 in accordance with an implementation. As illustrated, GUI screen 110 includes a pull-down menu 112 for use in adding one or more transmit datasets to a platform model.

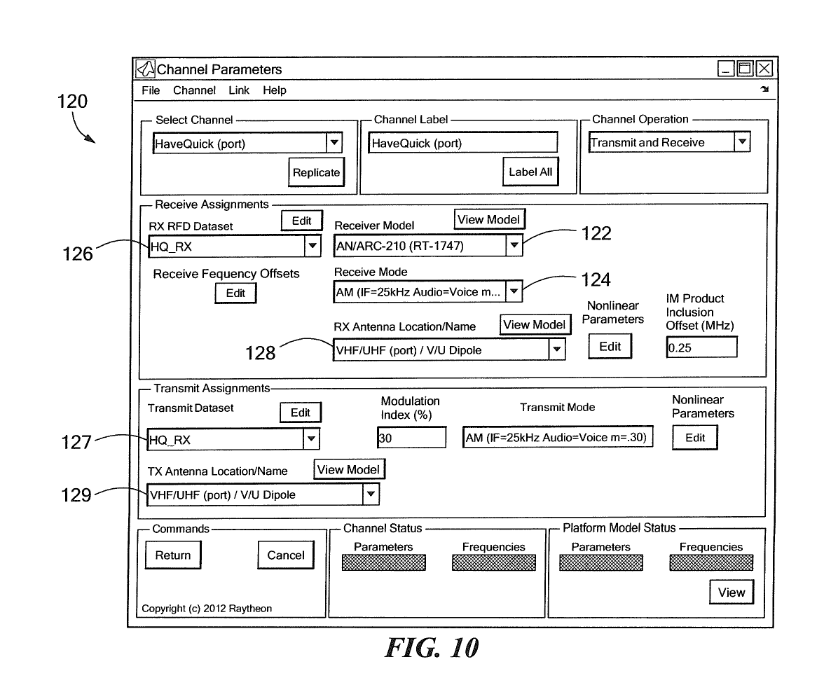

The channel parameters application 64 of FIG. 5 may be used to name and define radio channels by selecting an RFD data set, a receiver model, a receive mode, a receive antenna, a transmit data set, and/or a transmit antenna for the channel. FIG. 10 is a screen shot of an example GUI screen 120 that may be used in connection with channel parameters application 64 in accordance with an implementation.

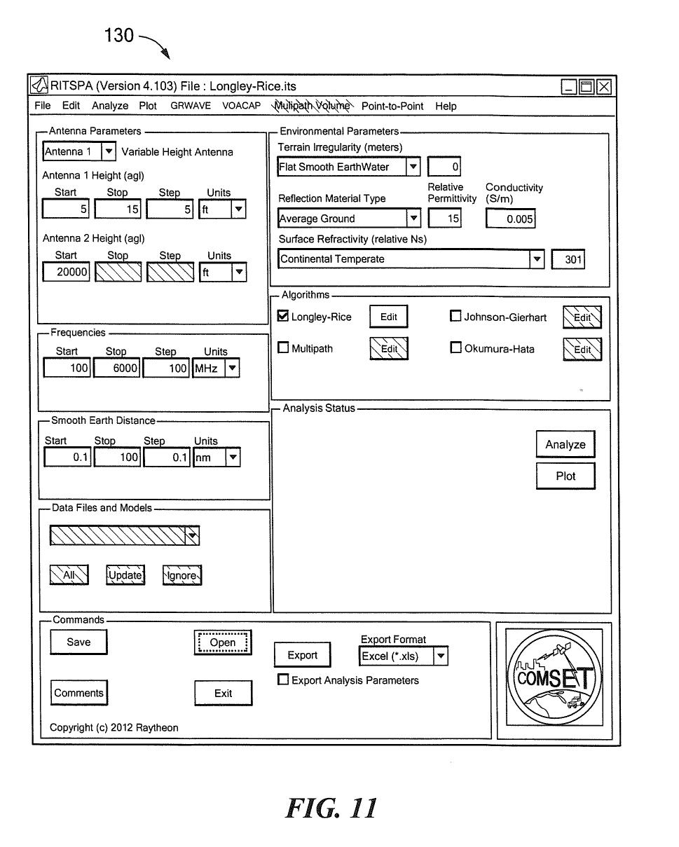

Propagation models may be created and/or modified in propagation model application 62 of FIG. 5 in some implementations. FIG. 11 is a screen shot of an example GUI screen 130 that may be used in connection with propagation model application 62 in accordance with an implementation. The propagation model application 62 may be used to define a specific propagation model and environmental characteristics that will be used for a given channel. Some propagation model algorithms that may be available include, for example: Longley-Rice, Johnson-Gierhart, 2-ray Multipath, Okumura-Hata, VOACAP, and GRWAVE. The Longley-Rice model may be used, for example, in area or point-to-point modes. In a point-to-point mode, Digital Terrain Elevation Data (DTED) data is used. In this case, propagation data is dependent on the specific location of the transmitter and the receiver on Earth.

As described above, platform model application 52 of FIG. 5 may be used to generate platform models for use during jamming effectiveness simulations. A platform model is a data structure that includes data characterizing the performance of one or more radio channels. A radio channel may be comprised of radio equipment such as antennas, transmitters, receivers, coax, filters, amplifiers, couplers, and/or other components. To generate a platform model, platform model application 52 may require input from one or more of: receive RFD datasets application 54, transmit datasets application 56, antenna model application 58, radio model application 60, propagation model application 62, and/or channel parameters application 64 in some implementations.

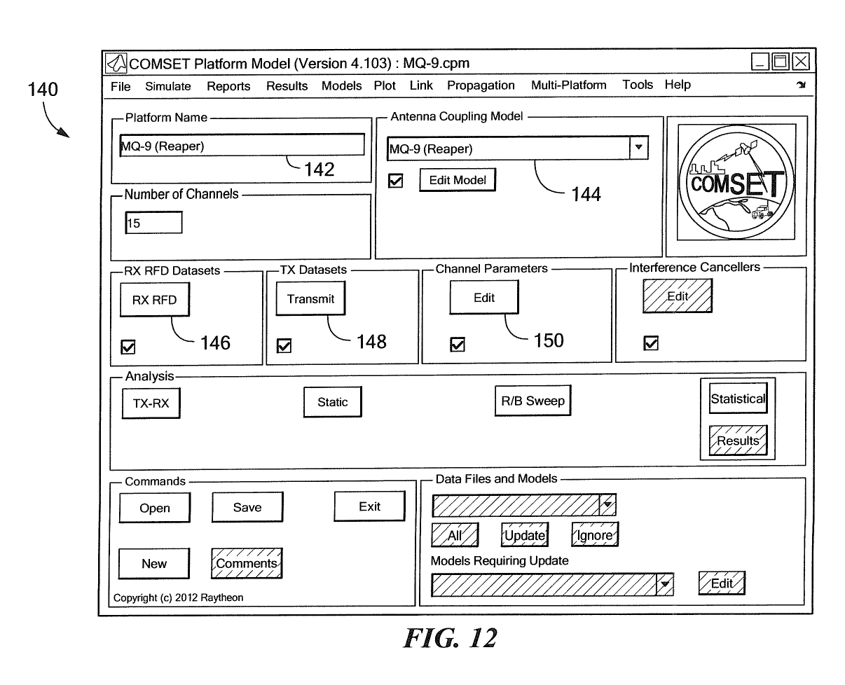

FIG. 12 is a screen shot of an example GUI screen 140 that may be used in connection with platform model application 52 in accordance with an implementation. As illustrated, GUI screen 140 includes a text box 142 that can be used to enter a name for a corresponding platform. A pull-down menu 144 may also be provided that allows a user to specify an antenna coupling model to use for the platform. GUI screen 180 may also include an “RX RFD” button 146 for use in importing receive RFD data sets into platform model application 52. Selection of the “RX RFD” button 146 opens GUI screen 100 of FIG. 8 associated with receive RFD dataset application 54. GUI screen 140 may further include a “Transmit” button 148 for use in importing transmitter data sets into platform model application 52. Selection of the “Transmit” button 148 opens GUI screen 110 of FIG. 9 associated with transmit dataset application 56. In addition to the above, GUI screen 140 may also include an “Edit” button 150 that may be used to import channel parameter information into platform model application 52. Selection of the “Edit” button 150 opens GUI screen 120 of FIG. 10 associated with channel parameters application 64. The receive RFD dataset, receiver model (from radio model), and transmit dataset are selected from GUI 120. The receiver model (radio model) is selected from a pull-down menu 122. The receiver mode, which determines the specific set of data used in the radio model, is selected from a pull-down menu 124. The receive RFD data (simulated in ADS) is selected from a pull-down menu 126. The transmitter dataset is selected from a pull-down menu 127.

For a selected receive RFD dataset, a user is able to select a receive antenna and location using a receive antenna location/name pull-down menu 128. For a selected transmit dataset, a user is able to select a transmit antenna and location using a transmit antenna location/name pull-down menu 129. In this manner, channels may be defined by a specific set of equipment as well as by a specific operating mode.

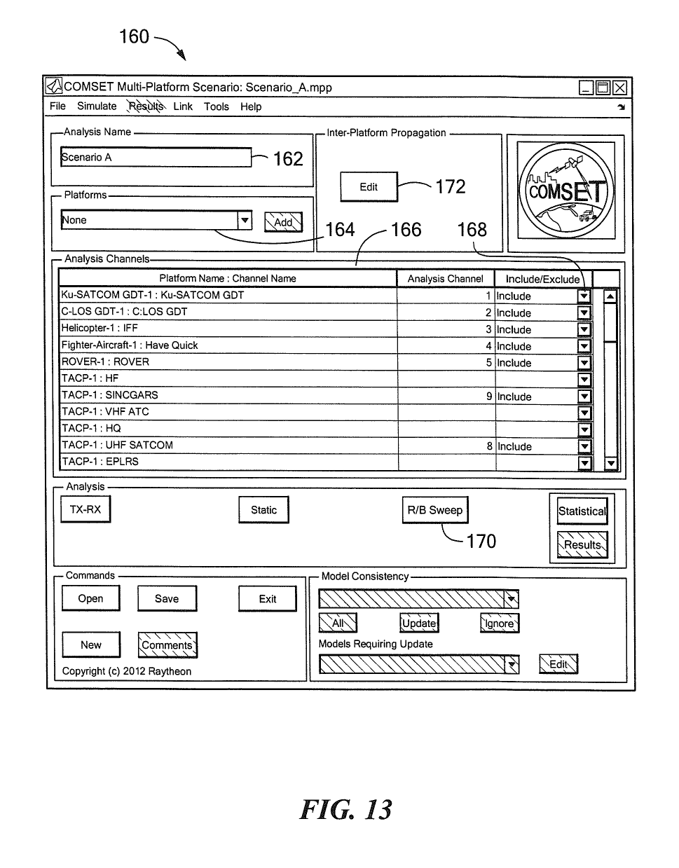

As described above, Multi-Platform Scenario application 66 of FIG. 5 may allow a user to select multiple platforms for use in a jamming effectiveness analysis. FIG. 13 is a screen shot of an example GUI screen 160 that may be used in connection with Multi-Platform Scenario application 66 in accordance with an implementation. As illustrated, GUI screen 160 may include an “analysis name” text box 162 to allow a user to enter a name for a given analysis. Platforms may be added to the analysis from a “platforms” pull-down menu 164. An “analysis channels” section 166 of GUI screen 160 may list a number of radio channels that can be added to a platform for analysis. Radio channels can be included or excluded using an include/exclude pull-down menu 168 associated with the radio channel. Each platform can have one or more radio channels associated with it. For a jamming effectiveness analysis, each platform will typically have only a single channel.

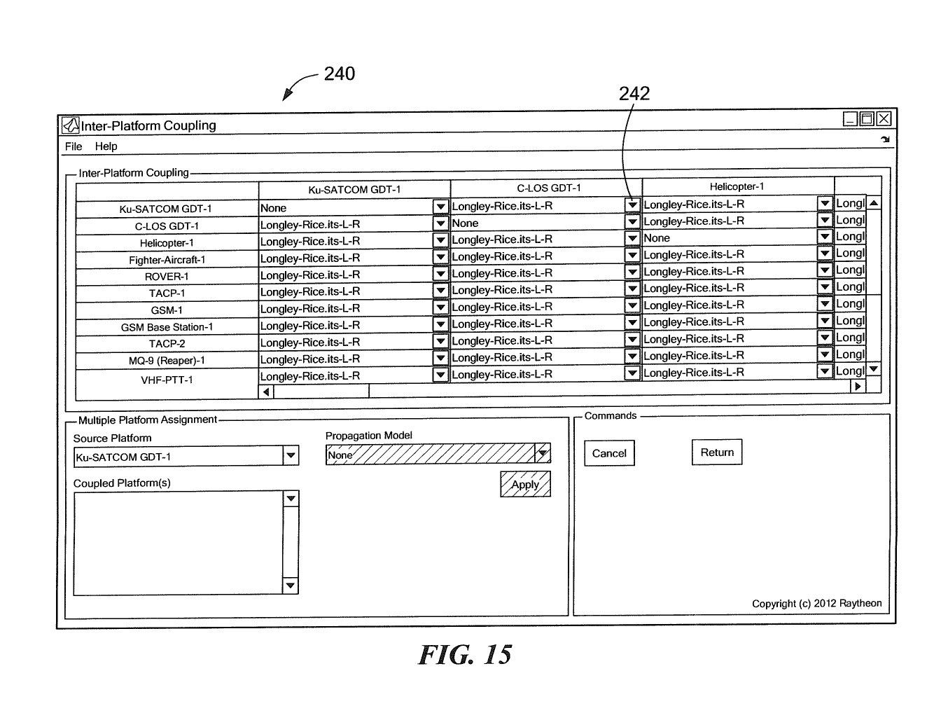

As described previously, for a jamming effectiveness analysis, two or more selected platform models will contain a radio transmitter (i.e., to represent the jamming transmitter and the threat transmitter) and at least one platform model will contain a radio receiver (i.e., to represent the threat receiver). After the platforms have been specified in GUI screen 160, an “Edit” button 172 may be pressed to activate inter-platform coupling application 74 of FIG. 5. FIG. 15 is a screen shot of a GUI screen 240 that may be used in connection with inter-platform coupling application 74 in accordance with an implementation. As illustrated in FIG. 15, GUI screen 240 may allow a different propagation model to be selected for each combination of platforms in an analysis. A drop down menu (e.g., drop down menu 242, etc.) of GUI screen 240 may be used to select a propagation model for use in the channel between the jammer platform and the threat receiver platform. As will be described in greater detail, a propagation model may be selected for use in the channel between the threat transmitter platform and the threat receiver platform in Range/Bearing Sweep Analysis application 68.

As described previously, to perform a jamming effectiveness analysis, the location of the threat transmitter (e.g., range and bearing, etc.) may be varied to collect signal level information at the threat receiver from both transmitter platforms. Range/Bearing Sweep Analysis application 68 of FIG. 5 may be used to sweep through the various locations of the threat transmitter during collection of the received signal level information. GUI screen 160 of FIG. 13 associated with Multi-Platform Scenario application 66 may include an “RIB Sweep” button 170 to allow a user to activate Range/Bearing Sweep Analysis application 68.

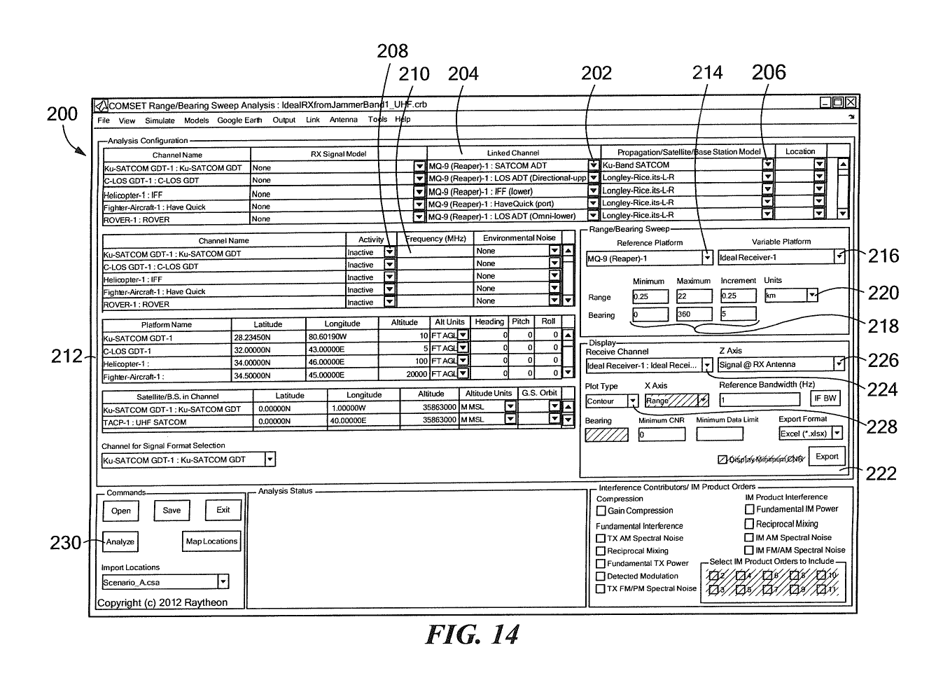

FIG. 14 is a screen shot of an example GUI screen 200 that may be used in connection with Range/Bearing Sweep Analysis application 68 in accordance with an implementation. As shown in FIG. 14, GUI screen 200 may allow a user to link a receive channel to a transmit channel by selecting the transmit channel from a pull-down menu 202 under a “Linked Channel” category 204. A propagation model may also be selected for a channel between the receive channel and the transmit channel using a pull-down menu 206. To perform a jamming effectiveness analysis, the threat transmitter channel and the threat receiver channel are entered using Range/Bearing Sweep Analysis application 68. Pull-down menu 206 is then used to specify the propagation model between the threat transmitter channel and the threat receiver channel. For each of the listed channels, a corresponding activity (i.e., inactive, transmit, or receive) may be selected from a pull-down menu 208. An operating frequency may also be entered in a text box 210.

For each specified platform, a platform location (e.g., latitude, longitude, and altitude) and attitude (e.g., heading, pitch, and roll) may be entered in corresponding fields 212 of GUI 200. A reference platform may be selected using a reference platform pull-down menu 214 and a variable platform may be selected using a variable platform pull-down menu 216. The reference platform will remain stationary during the sweep analysis and the variable platform will be moved during the sweep analysis. During a jamming effectiveness analysis, the reference platform will be the threat receiver and the variable platform will be the threat transmitter.

The specifics of the sweep to be performed for the jamming effectiveness analysis may next be entered by the user. In general, any type of information may be specified to define the threat transmitter locations for use during the analysis. In GUI screen 200 of FIG. 14, for example, text boxes 218 are provided for entering a minimum range, a maximum range, a range increment, a minimum bearing, a maximum bearing, and a bearing increment. A pull-down menu 220 may also be provided to allow a user to specify the units of the range information.

GUI screen 200 of FIG. 14 also includes a display section 222 to allow a user to define information to be plotted. As illustrated, display section 222 may include a receive channel pull-down menu 224 to define a type of receive channel to use in the analysis and a Z-Axis pull down menu 224 to define the parameter to plot on the z-axis on the resulting graph. For a jamming effectiveness analysis, the z-axis may be selected to be, for example, “Interference to Signal” or “carrier-to-noise ratio (CNR).” A “Plot Type” pull-down menu 226 may also be provided to allow a user to specify a type of plot to be generated. For a jamming effectiveness analysis, a contour plot may be selected as a plot type. After the analysis information has been specified by the user, the “Analyze” button 230 of GUI screen 200 may be pressed to initiate the simulation. At each threat transmitter location (e.g., range and bearing) during the simulation, a signal-to-interference ratio (SIR) and a jam-to-signal ratio (JSR) may be calculated and stored. As described previously, in at least one embodiment, the COMSET interference analysis tool may be used to perform this function.

As described above, to perform a jamming effectiveness analysis, two platform models need to be selected that include transmitter channels. When a transmitter channel is selected for a platform in the Range/Bearing Sweep Analysis application 68, a transmitter model provides an output power spectral density for the transmitter channel and an antenna model provides a 3-dimensional gain pattern, including polarization characteristics, for the channel. The transmitter channel may include data at all operating frequencies in some implementations. The orientation of the transmit antenna may be set relative to the platform orientation by, for example, Range/Bearing Sweep Analysis application 68. This may be accomplished by rotating the antenna gain pattern and polarization about the x, y, and z axes using a 3-dimensional rotation matrix. Rotation of the antenna gain pattern may be accomplished, for example, by applying the following series of equations. For rotation about the z-axis in the x-y plane:

x_{z}=x·cos(α_{z})+y·sin(α_{z})

y_{z}=−x·sin(α_{z})+y·cos(α_{z}),

for rotation about the y axis in the x-z plane:

x_{y}=x_{z}·cos(α_{y})−z·sin(α_{y})

z_{y}=x_{z}·sin(α_{y})+z·cos(α_{y}) and

for rotation about the x axis in the y-z plane:

yₓ=y_{z}·cos(αₓ)+z_{y}·sin(αₓ)

zₓ=−y_{z}·sin(αₓ)+z_{y}·cos(αₓ)

where α is the angular rotation in radians. The same equations may be applied to the polarization rotation after converting the complex orthogonal directivities from spherical coordinates to Cartesian coordinates. The data provided from this platform, which includes a transmit channel, may include an Effective Isotropic Radiated Power (EIRP). The EIRP may be calculated using the following equation:

EIRP(x,y,z)=Gₜ(x,y,z)∫_{-∞}^{∞}P_{c}(Δf)·δΔf

where Gₜ(x,y,z) is the transmit antenna gain at each receiver location (unitless) and P_{c}(Δt) is the transmit power spectral density (W/Hz). The above may be performed for each platform model that includes a transmitter channel (i.e., the jamming transmitter platform model and the threat transmitter platform model).

As with the transmitter platform models discussed above, when a receiver channel is selected for a platform in the Range/Bearing Sweep Analysis application 68, an orientation of a receive antenna may be set relative to the corresponding platform orientation. The orientation of the receive antenna may be set using, for example, the same rotation equations used for the transmit antenna orientation.

As described above, to perform a jamming effectiveness analysis, the variation of the location (e.g., range and bearing) of the threat transmitter platform may be input to the Range/Bearing Sweep Analysis application 68, 200. The “Analyze” button 230 (FIG. 14) may then be pressed to begin the simulation. During the simulation, the power level at the receive antenna output of the threat receiver platform resulting from transmissions from the threat transmitter platform may be calculated and stored in memory as a function of threat transmitter location. The power level at the receive antenna output of the threat receiver platform resulting from transmissions from the jamming transmitter platform may also be calculated and stored in memory. This power level information may then be entered into an interference analysis program or system to determine the jamming effectiveness.

In at least one implementation, received power level from a transmitter platform may be calculated using the following equation:

$$\begin{matrix}{P}_{r} ( x , y , z ) = \frac{EIRP ( x , y , z ) {G}_{r} ( x , y , z )}{{L}_{p} ( x , y , z ) {P}_{L} ( x , y , z )} \\ = \frac{{P}_{t} {G}_{t} ( x , y , z ) {G}_{r} ( x , y , z )}{{L}_{p} ( x , y , z ) {P}_{L} ( x , y , z )}\end{matrix}$$

where EIRP(x,y,z) is the Effective Isotropic Radiated Power at a receiver location (Watts), Lₚ(x,y,z) is the propagation loss at the receiver location (unitless), P_{L}(x,y,z) is the polarization loss at the receiver location (unitless), Gᵣ(x,y,z) is the receive antenna gain at the receiver location (unitless), Pₜ is the transmit power (Watts), and Gₜ(x,y,z) is the transmit antenna gain at the receiver location (unitless). The polarization loss may be calculated using the following equation:

$${P}_{L} = {[ {cos}^{2} ( \frac{PaPw}{2} ) ]}^{- 1}$$

where PaPw is the great circle angle between the wave polarization and antenna polarization on a Poincare′ Sphere given as:

PaPw=cos⁻¹ [cos(2γ_{w})cos(2γₐ)+sin(2γ_{w})sin(2γₐ)cos(δ_{w}−δₐ)]

where γ_{w} is the transmitted wave vector angle at the receive antenna for the orthogonal components of the electric field, δ_{w} is the phase difference between orthogonal components of the transmitted wave at the receive antenna, γₐ is the receive antenna vector angle for the orthogonal components of the electric field, and δₐ is the phase difference between the orthogonal components of the receive antenna.

In another approach, probabilistic techniques may be used to analyze jamming effectiveness. In this approach, the effectiveness of a jamming operation may be expressed as a probability that a jammer-to-signal ratio (JSR) at the receiver location is adequate to effectively disrupt threat communications. Probability density functions (pdfs) may first be determined for a jammer path loss and a threat communication path loss. These pdfs may then be used to determine a pdf for a difference between jammer path loss and communication path loss. The pdf for the difference may then be analyzed to determine the jamming effectiveness probability.

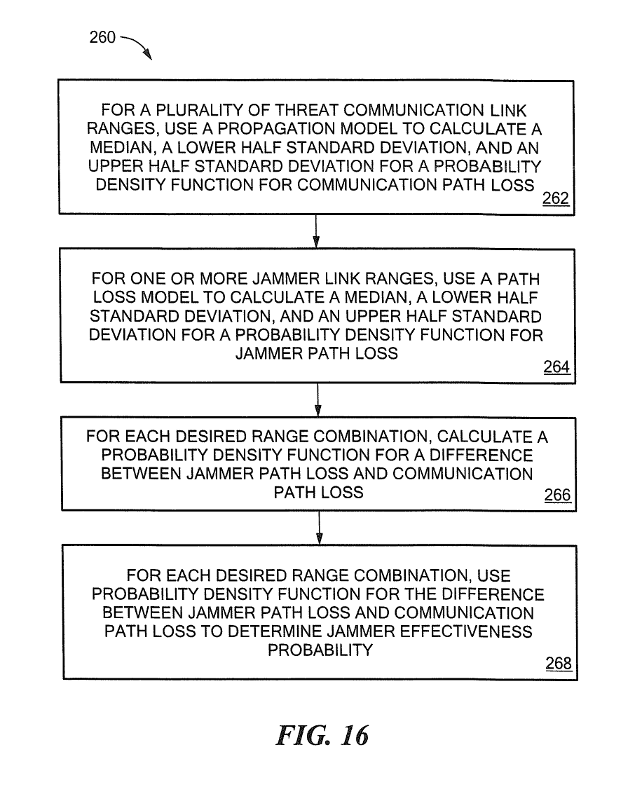

FIG. 16 is a flow diagram illustrating an example method 260 for determining jammer effectiveness using probabilistic techniques in accordance with an implementation. For a plurality of threat communication link ranges, a propagation model is used to calculate a median, a lower half standard deviation, and an upper half standard deviation for a probability density function (pdf) for communication path loss (block 262). In at least one implementation, the Longley-Rice model is used as the propagation model. For one or more jammer link ranges, the propagation model is again used to calculate a median, a lower half standard deviation, and an upper half standard deviation for a probability density function (pdf) for jammer path loss (block 264). For each desired range combination, a pdf may then be calculated for the difference between the jammer path loss and the communication path loss (block 266). For each desired range combination, the pdf calculated for the difference between the jammer path loss and the communication path loss may then be analyzed to determine jammer effectiveness probability (block 268).

To calculate the median, the lower half standard deviation, and the upper half standard deviation for the probability density function (pdf) for communication path loss using the Longley-Rice model, the model may be run a number of times for different combinations of associated analysis parameters. The Longley-Rice model uses three different analysis parameters to characterize a propagation channel; namely, a time reliability percentile, a location reliability percentile, and a confidence percentile. The time reliability percentile accounts for attenuation variations due to, for example, changes in atmospheric conditions. The location reliability percentile accounts for variations that occur between paths due to, for example, varying terrain and other environmental factors. The confidence percentile accounts for variations in other unspecified or hidden factors. Table 1 below shows seven combinations of these different analysis parameters that may be used to determine the median, the lower half standard deviation, and the upper half standard deviation for the communication path loss pdf. The Longley-Rice model may be run for each of the seven combinations, and the results may be used to determine the median, the lower half standard deviation, and the upper half standard for the communication path loss pdf. As shown in the table, in a first combination, each of the

TABLE 1

| Time Reliability | Location Reliability | Confidence |
|---|---|---|
| Percentile | Percentile | Percentile |
| 50% | 50% | 50% |
| 10% | 50% | 50% |
| 90% | 50% | 50% |
| 50% | 10% | 50% |
| 50% | 90% | 50% |
| 50% | 50% | 10% |
| 50% | 50% | 90% |

parameters are set at 50%. This combination of parameters may be used to determine the median for the communication path loss. In each of the next six combinations in Table 1, one parameter is set to either 10% or 90%, while the other two are kept at 50%. The 10% and 50% values are used to determine a lower standard deviation for each analysis parameter. The 50% and 90% values are used to determine an upper standard deviation for each analysis parameter. The standard deviations for the three parameters are then combined to form a single pair of upper and lower standard deviations for the communication path loss.

The above-described process may then be repeated for each of the specified threat communication link ranges. The same process may then be used to determine the median, the lower half standard deviation, and the upper half standard deviation for the pdf for jammer path loss for the one or more jammer link ranges.

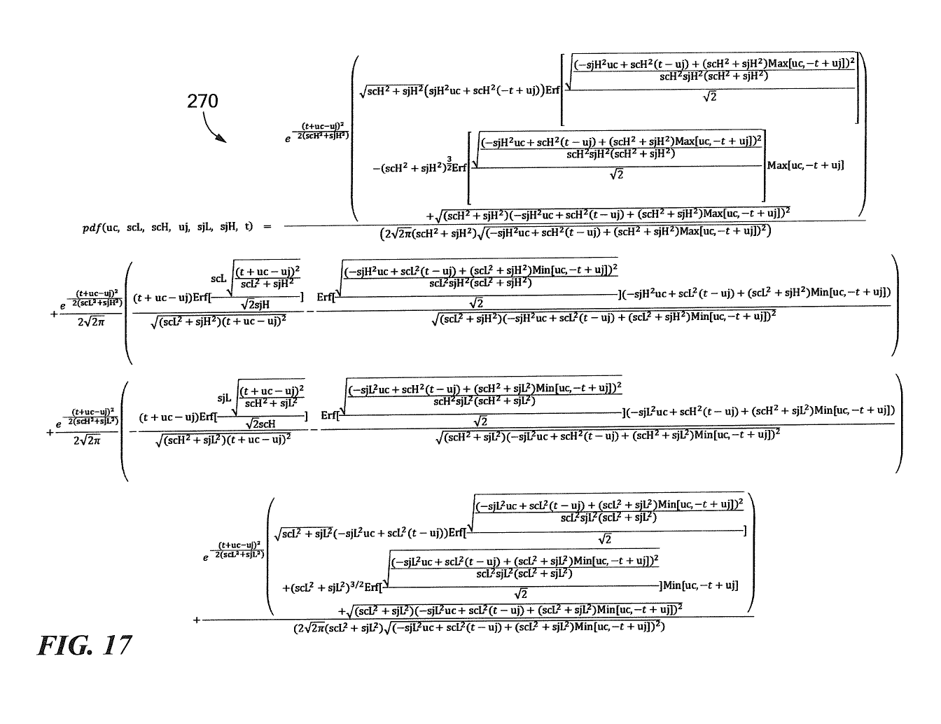

As described above, a pdf may next be generated for the difference between the jammer path loss and the communication path loss for each desired range combination. Each range combination will include one communication link range and one jammer link range. FIG. 17 illustrates an equation 270 that may be used to generate a pdf for the difference between a jammer path loss and a communication path loss for a particular range combination in accordance with an embodiment. In equation 270, uc denotes the communication link median, scL denotes the communication link lower half standard deviation, scH denotes the communication link upper half standard deviation, uj denotes the jammer link median, sjL denotes the jammer link lower half standard deviation, sjH denotes the jammer link upper half standard deviation, and t denotes the difference between jammer path loss and communication path loss.

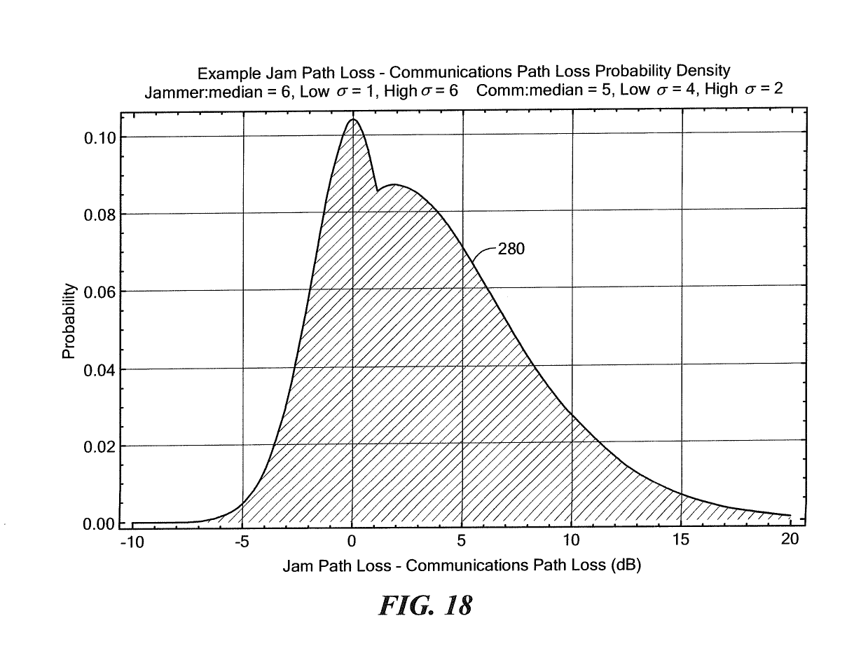

FIG. 18 is a plot illustrating an example pdf 280 that may be generated for the difference between the jammer path loss and the communication path loss for a particular range combination. The pdf 280 may be generated using, for example, equation 270 of FIG. 17. As illustrated, the pdf 280 is for a jammer path loss pdf having a median of 6, a lower half standard deviation of 1, and an upper half standard deviation of 6 and a communication path loss pdf having a median of 5, a lower half standard deviation of 4, and an upper half standard deviation of 2. A similar pdf may be generated for each desired range combination. The generated pdfs may be stored in a memory of the corresponding system (e.g., memory 14 of FIG. 1). The resulting pdfs may then be used to determine jammer effectiveness probabilities as a function of communication range and/or jammer range. The jammer effectiveness probabilities may then be plotted.

To determine a jammer effectiveness probability using a pdf (e.g., pdf 280 of FIG. 18, etc.), the pdf may be integrated from −∞ to a difference value that is selected based on a predetermined effectiveness condition. In order to jam effectively, the following relationship must be satisfied:

(Jammer EIRP+Bandwidth Ratio−JPL)−(Communication Link EIRP−CPL)>Required J/S

where Jammer EIRP is the Jammer Effective Isotropic Radiated Power, bandwidth ratio is the ratio of communications bandwidth to jamming bandwidth, JPL is the jammer path loss, communication link EIRP is the threat link Effective Isotropic Radiated Power, CPL is the communication path loss, and required J/S is the jammer-to-signal ratio needed to effectively jam. Table 2 lists a number of variable values for an example scenario for which jamming

TABLE 2

| | | |
|---|---|---|
| Jammer EIRP | 75 | dBm |
| Communication Link EIRP | 30 | dBm |
| Required J/S | 0 | dB |
| Jamming Bandwidth | 26 | MHz |
| Communications Bandwidth | 200 | kHz |
| Bandwidth Ratio | −21.1394 | dB |

| | |
|---|---|
| Jammer Path Loss | Jpl |
| Communication Link Path Loss | Cpl |

effectiveness information may be desired. Substituting the values from the table into the above equation and solving for JPL−CPL results in:

23.8606>JPL−CPL

This value for the difference between JPL and CPL may then be used as the upper bound of the integration range for the difference pdf (e.g., pdf 280 of FIG. 18, etc.). That is, to get the jamming effectiveness probability, the difference pdf may be integrated from −∞ to 23.8606. This process may then be repeated for other range combinations to determine probabilities for those combinations. The resulting probabilities may then be plotted on a contour graph.

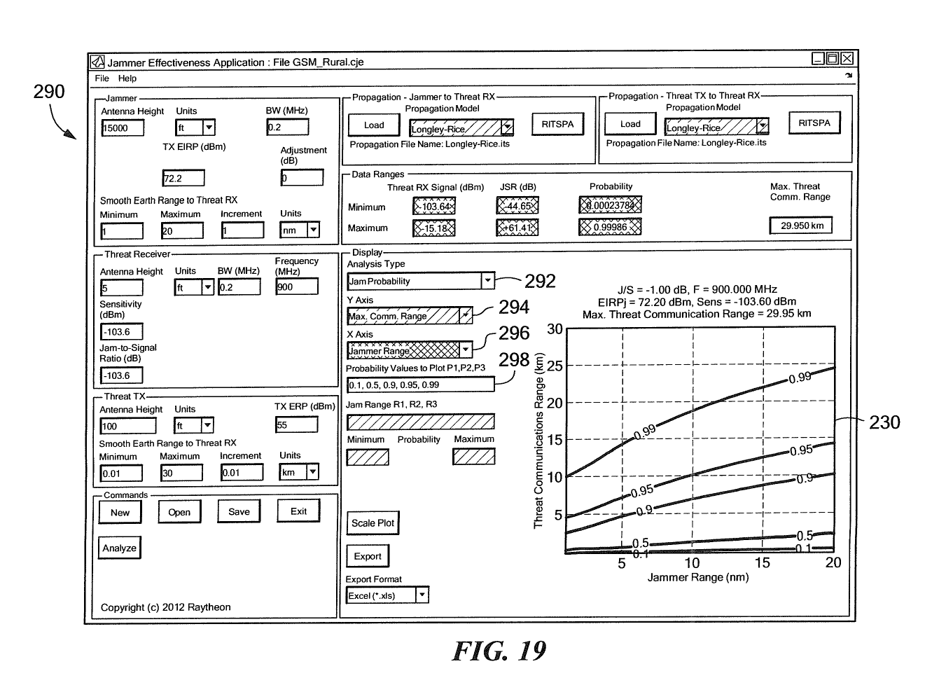

FIG. 19 is a screen shot of a GUI screen 290 that may be used as part of a probability based jamming effectiveness application in accordance with an implementation. As illustrated, GUI screen 290 includes a number of text boxes and drop down menus that may be used to enter the jammer and communication radio parameters, including the parameters needed by the Longley-Rice propagation model. This information may include, for example, antenna heights, bandwidths, transmitter EIRP, jammer and threat communication ranges, threat receiver sensitivity, and jam-to-signal ratio. The specifics of the Longley-Rice propagation model are well known in the art. In some alternative embodiments, radio models that include some or all of this information may be specified by a user instead of using the direct entry method discussed above. The radio models may be stored within, for example, a model database or library within the system.

GUI screen 290 may also include input fields/drop down menus for use in specifying parameters for use in displaying results of the analysis. For example, an “analysis type” drop down menu 292 may be provided for selecting a type of analysis to plot. A “y-axis” drop down menu 294 may be provided for selecting a parameter to plot on the y-axis of the plot. An “x-axis” drop down menu 296 may be provided for selecting a parameter to plot on the x-axis of the plot. A “probability values” text box 298 may be provided to enter probability values to plot when a contour plot is being generated. For a jammer effectiveness analysis, “Jam Probability” may be selected as an analysis type in drop down menu 292. If “Jam Probability” is selected as the analysis type, the y-axis of the plot may be automatically set to “threat communication range.” Drop down menu 296 may then be used to select the parameter for the x-axis of the plot. As shown in FIG. 19, one possibility for the x-axis parameter is “jammer range.” This will result in a plot (e.g., plot 230) where threat communication range is plotted against jammer range. The plot 230 may include a number of curves, where each curve corresponds to a particular probability. The values specified in the “probability values” text box 298 will define the probabilities that are plotted as curves. In plot 230 of FIG. 19, for example, curves are plotted for probability values of 0.1, 0.5, 0.9, 0.95, and 0.99. In another type of jammer probability plot, threat communication range may be plotted on the y-axis and jammer effectiveness probability may be plotted on the x-axis for a single jammer range value. Other plot types may also be available.

In the description above, various GUI screens are described that may be used to facilitate the entry of user selections, specifications, and/or input data from a user in connection with an analysis to be performed. It should be understood that these specific screens are not meant to be limiting and other alternative information entry techniques and/or structures may be used in other implementations. These other techniques and structures may include both GUI based and non-GUI based approaches.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A machine-implemented method for predicting jamming effectiveness, comprising:
receiving input information specifying a threat receiver platform model describing a threat receiver;
receiving input information specifying a threat transmitter platform model describing a threat transmitter;
receiving input information specifying a jamming transmitter platform model describing a jamming transmitter;
receiving input information specifying a first channel propagation model for a channel between the threat transmitter and the threat receiver;
receiving input specifying a second channel propagation model for a channel between the jamming transmitter and the threat receiver;
receiving input information specifying a number of threat transmitter locations; and
performing a first series of interference analyses corresponding to the number of threat transmitter locations using the threat receiver platform model, the threat transmitter platform model, the jamming transmitter platform model, the first channel propagation model, and the second channel propagation model, each of the first series of interference analyses resulting in a receiver performance metric value, wherein the first series of interference analyses hold the location of the jamming transmitter and the threat receiver constant.

2. The method of claim 1, further comprising:
performing a second series of interference analyses corresponding to the number of threat transmitter locations using the threat receiver platform model, the threat transmitter platform model, and the first channel propagation model with no jamming, each of the second series of interference analyses resulting in a receiver performance metric value, wherein the second series of interference analyses hold the location of the jamming transmitter and the threat receiver constant; and
comparing results from the first and second series of interference analyses to determine jammer effectiveness.

3. The method of claim 2, wherein:
comparing results from the first and second series of interference analyses to determine jammer effectiveness includes determining a maximum communication range with jamming using results of the first series of interference analyses, determining a maximum communication range without jamming using results of the second series of interference analyses, and calculating a ratio between the maximum communication range with jamming and the maximum communication range without jamming.

4. The method of claim 2, wherein:
comparing results from the first and second series of interference analyses to determine jammer effectiveness includes evaluating the following equation:
$${J}_{eff} = ( 1 - \frac{{R}_{j}}{{R}_{max}} ) \times 100 \% .$$
where J_{eff} is the jamming effectiveness, Rⱼ is the maximum communication range with jamming determined using results of the first series of interference analyses, and Rₘₐₓ is the maximum communication range without jamming determined using results of the second series of interference analyses.

5. The method of claim 1, wherein:
the receiver performance metric value is a carrier-to-noise ratio (CNR) value.

6. A system for predicting jamming effectiveness, comprising:
one or more processors to:
receive input information specifying a threat receiver platform model describing a threat receiver;
receive input information specifying a threat transmitter platform model describing a threat transmitter;
receive input information specifying a jamming transmitter platform model describing a jamming transmitter;
receive input information specifying a first channel propagation model for a channel between the threat transmitter and the threat receiver;
receive input specifying a second channel propagation model for a channel between the jamming transmitter and the threat receiver;
receive input information specifying a number of threat transmitter locations; and
perform a first series of interference analyses corresponding to the number of threat transmitter locations using the threat receiver platform model, the threat transmitter platform model, the jamming transmitter platform model, the first channel propagation model, and the second channel propagation model, each of the first series of interference analyses resulting in a receiver performance metric value, wherein the first series of interference analyses hold the location of the jamming transmitter and the threat receiver constant; and
a memory to store a library of transmitter models, receiver models, antenna models, propagation models, and channel parameter models for use in generating platform models.

7. The system of claim 6, wherein said one or more processors includes a processor to:
perform a second series of interference analyses corresponding to the number of threat transmitter locations using the threat receiver platform model, the threat transmitter platform model, and the first channel propagation model with no jamming, each of the second series of interference analyses resulting in a receiver performance metric value, wherein the second series of interference analyses hold the location of the jamming transmitter and the threat receiver constant; and
compare results from the first and second series of interference analyses to determine jammer effectiveness.

8. The system of claim 7, wherein:
said processor is configured to compare results from the first and second series of interference analyses to determine jammer effectiveness by determining a maximum communication range with jamming using results of the first series of interference analyses, determining a maximum communication range without jamming using results of the second series of interference analyses, and calculating a ratio between the maximum communication range with jamming and the maximum communication range without jamming.

9. The system of claim 8, wherein:
said processor is configured to compare results from the first and second series of interference analyses to determine jammer effectiveness by evaluating the following equation:
$${J}_{eff} = ( 1 - \frac{{R}_{j}}{{R}_{max}} ) \times 100 \% .$$
where J_{eff} is the jamming effectiveness, Rⱼ is the maximum communication range with jamming determined using results of the first series of interference analyses, and Rₘₐₓ is the maximum communication range without jamming determined using results of the second series of interference analyses.

10. A machine implemented method for analyzing jamming effectiveness for a jamming transmitter that is intended to disrupt communications between a threat transmitter and a threat receiver, comprising:
for a plurality of threat communication link ranges, calculating a median, a lower half standard deviation, and an upper half standard deviation for a probability density function for communication path loss using a first propagation model, wherein a threat communication link range is a range between the threat transmitter and the threat receiver;
for one or more jamming link ranges, calculating a median, a lower half standard deviation, and an upper half standard deviation for a probability density function for jamming path loss using the first propagation model, wherein a jamming link range is a range between the jamming transmitter and the threat receiver;
for each desired range combination, generating a probability density function for a difference between jammer path loss and threat communication path loss using the median, the lower half standard deviation, and the upper half standard deviation for the probability density function for threat communication path loss and the median, the lower half standard deviation, and the upper half standard deviation for the probability density function for jammer path loss, wherein a range combination is a combination of a threat communication link range and a jamming link range; and
for each desired range combination, using the probability density function for the difference between jammer path loss and threat communication path loss to determine a jammer effectiveness probability.

11. The method of claim 10, wherein:
said first propagation model is a Longley-Rice propagation model.

12. The method of claim 11, wherein:
calculating a median, a lower half standard deviation, and an upper half standard deviation for a probability density function for communication path loss using the first propagation model includes evaluating the Longley-Rice propagation model for a number of different combinations of a time reliability percentile, a location reliability percentile, and a confidence percentile and using results of the evaluations to calculate the median, the lower half standard deviation, and the upper half standard deviation for the probability density function for communication path loss.

13. The method of claim 12, wherein:
calculating a median, a lower half standard deviation, and an upper half standard deviation for a probability density function for jamming path loss using the first propagation model includes evaluating the Longley-Rice propagation model for a number of different combinations of a time reliability percentile, a location reliability percentile, and a confidence percentile and using results of the evaluations to calculate the median, the lower half standard deviation, and the upper half standard deviation for the probability density function for jamming path loss.

14. The method of claim 10, wherein:
generating a probability density function for a difference between jammer path loss and threat communication path loss using the median, the lower half standard deviation, and the upper half standard deviation for the probability density function for threat communication path loss and the median, the lower half standard deviation, and the upper half standard deviation for the probability density function for jammer path loss includes evaluating an equation using these parameters.

15. The method of claim 10, wherein:
using the probability density function includes integrating the probability density function for the difference between jammer path loss and threat communication path loss from −∞ to a predetermined value to determine a jammer effectiveness probability.

16. The method of claim 15, wherein:
the predetermined value is calculated based on a mathematical relationship that is intended to result in effective jamming.

17. The method of claim 16, wherein:
the mathematical relationship includes the inequality:
(Jammer EIRP+Bandwidth Ratio−JPL)−(Communication Link EIRP−CPL)>Required J/S
where Jammer EIRP is the Jammer Effective Isotropic Radiated Power, bandwidth ratio is the ratio of communications bandwidth to jamming bandwidth, JPL is the jammer path loss, communication link EIRP is the threat link Effective Isotropic Radiated Power, CPL is the communication path loss, and required J/S is the jammer-to-signal ratio needed to effectively jam.

18. A system for predicting jamming effectiveness for a jamming transmitter that is intended to disrupt communications between a threat transmitter and a threat receiver, comprising:
one or more processors to:
calculate a median, a lower half standard deviation, and an upper half standard deviation for a probability density function for communication path loss using a first propagation model for a plurality of threat communication link ranges, wherein a threat communication link range is a range between the threat transmitter and the threat receiver;
calculate a median, a lower half standard deviation, and an upper half standard deviation for a probability density function for jamming path loss using the first propagation model for one or more jamming link ranges, wherein a jamming link range is a range between the jamming transmitter and the threat receiver;
generate a probability density function for a difference between jammer path loss and threat communication path loss using the median, the lower half standard deviation, and the upper half standard deviation for the probability density function for threat communication path loss and the median, the lower half standard deviation, and the upper half standard deviation for the probability density function for jammer path loss for each desired range combination, wherein a range combination is a combination of a threat communication link range and a jamming link range; and
for each desired range combination, use the corresponding probability density function for the difference between jammer path loss and threat communication path loss to determine a jammer effectiveness probability; and
a memory to store generated probability density functions.

19. The system of claim 18, wherein:
the one or more processors calculates the median, the lower half standard deviation, and the upper half standard deviation for the probability density function for communication path loss by evaluating a Longley-Rice propagation model for a number of different combinations of a time reliability percentile, a location reliability percentile, and a confidence percentile and using results of the evaluations to calculate the median, the lower half standard deviation, and the upper half standard deviation for the probability density function for communication path loss.

20. The system of claim 18, wherein:
the one or more processors calculates the median, the lower half standard deviation, and the upper half standard deviation for the probability density function for jamming path loss by evaluating the Longley-Rice propagation model for a number of different combinations of a time reliability percentile, a location reliability percentile, and a confidence percentile and using results of the evaluations to calculate the median, the lower half standard deviation, and the upper half standard deviation for the probability density function for jamming path loss.

21. The system of claim 18, wherein:
the one or more processors calculates the probability density function for the difference between jammer path loss and threat communication path loss using the median, the lower half standard deviation, and the upper half standard deviation for the probability density function for threat communication path loss and the median, the lower half standard deviation, and the upper half standard deviation for the probability density function for jammer path loss by evaluating an equation using these parameters.

22. The system of claim 18, wherein:
the one or more processors use the probability density function by integrating the probability density function from −∞ to a predetermined value to determine a jammer effectiveness probability.

23. The system of claim 22, wherein:
the predetermined value is calculated based on a mathematical relationship that is intended to result in effective jamming.

24. The system of claim 23, wherein:
the mathematical relationship includes the inequality:
(Jammer EIRP+Bandwidth Ratio−JPL)−(Communication Link EIRP−CPL)>Required J/S
where Jammer EIRP is the Jammer Effective Isotropic Radiated Power, bandwidth ratio is the ratio of communications bandwidth to jamming bandwidth, JPL is the jammer path loss, communication link EIRP is the threat link Effective Isotropic Radiated Power, CPL is the communication path loss, and required J/S is the jammer-to-signal ratio needed to effectively jam.
